(19) United States
(12) Patent Application Publication
(10) Pub. No.: US 2025/0389912 A1
(43) Pub. Date: Dec. 25, 2025

(54) Shear Resistant Conformal Thermal Gap Filler Assembly for Pluggable Optical Module Heatsinks

(71) Applicant: Ciena Corporation, Hanover, MD (US)

(72) Inventors: Peter Ajersch, Ottawa (CA); Trevor Meunier, Kemptville (CA)

(21) Appl. No.: 18/748,335

(22) Filed: Jun. 20, 2024

(51) Int. Cl. G02B 6/42

(52) U.S. Cl. CPC G02B 6/4269; G02B 6/4261; G02B 6/4267; G02B 6/4278

(57) ABSTRACT

A shear resistant conformal thermal gap filler assembly for a circuit pack including a heatsink base collocated with an opening in a cage adapted to receive a pluggable optical module, a thermally conductive compressible material layer disposed on the heatsink base, and a thermally conductive shear resistant bearing surface disposed adjacent to the thermally conductive compressible material layer opposite the heatsink base, where the thermally conductive shear resistant bearing surface is adapted to contact a surface of the pluggable optical module through the opening in the cage when the pluggable optical module is received within the cage, and where the thermally conductive compressible material layer and the thermally conductive shear resistant bearing surface are adapted to conform to deviations in the surface of the pluggable optical module.

### TECHNICAL FIELD

The present disclosure relates generally to the telecommunications and optical networking fields. More particularly, the present disclosure relates to a shear resistant conformal thermal gap filler assembly for pluggable optical module (POM) heatsinks.

### BACKGROUND

A dry sliding contact heatsink is often used for cooling a user replaceable POM within a circuit pack, with dry sliding contact between the top (or bottom) of the POM and the contact surface of the heatsink. These surfaces are theoretically coplanar, however, in reality, form deviation, waviness, texture, and roughness of the surfaces (both the POM contact surface and the heatsink base (or pedestal)) mean that, on a micro-scale, the interaction between the surfaces is a mixture of areas of metal-to-metal contact and gaps (typically on the order of 50-100 microns in height). These gaps increase thermal contact resistance between the POM and the heatsink and limit the ability to effectively cool high power POMs, such as newer generation 800G transceivers and the like.

Improvements to bare metal-to-metal contact have included the placement of a thermal gap pad between the POM contact surface and the heatsink base, the application of a thin, durable, and compliant thermal interface material (TIM) to the heatsink base (such as micro-TIM offered by Henkel Corp.), and the application of a laminate of a polymer and a phase-change material to the heatsink base, with the phase-change material transitioning to conform to the interstitial space when the POM becomes warm and the polymer allowing the surfaces to slide against one another over multiple POM insertion-removal cycles.

However, these conventional approaches suffer from several significant limitations and problems. The thermal gap pad tends to be thick and itself have significant thermal resistance and is prone to compression set. Furthermore, the tackiness and weakness of a conventional gap pad does not allow for insertion and removal of the POM without an additional mechanism for lifting and dropping the heatsink. The TIM and laminate often fail to fully close all gaps.

The present background is provided as environmental context only. It will be readily apparent to those of ordinary skill in the art that the principles and concepts of the present disclosure may be implemented in other environmental contexts equally, without limitation.

### SUMMARY

The present disclosure provides a shear resistant conformal thermal gap filler assembly for POM heatsinks that generally includes a compressible material applied to the heatsink base (or pedestal) and covered by a shear resistant bearing surface that directly contacts the POM contact surface when the POM is inserted into the associated POM cage. The compressible material includes, for example, a 0.5-1 mm thick layer of aligned graphite or the like that is thermally conductive (10-80 W/mK) and (elastically) rebounds with limited compression set with removal of the POM from the associated POM cage. The shear resistant bearing surface includes a thin slotted metallic structure or the like that adequately flexes and conforms to the POM contact surface and the compressible material, while protecting the compressible material from shear damage with POM insertion/removal. A TIM coating may be provided on the shear resistant bearing surface opposite the compressible material to further improve (reduce) the contact/thermal resistance between the heatsink base and the POM contact surface. A lead-in retaining feature may be utilized to protect the leading edge of the shear resistant bearing surface during POM insertion. This lead-in retaining feature may be secured to the heatsink base in a fixed manner. A back end retaining feature may be secured to the heatsink base and allow for some movement of the shear resistant bearing surface along the front-to-back length axis of the POM to ensure flexibility and take up tolerances.

The thin and slotted nature of the shear resistant bearing surface and the compressibility of the material underneath collectively serve to fill the majority of air gaps between the POM contact surface and the heatsink base (or pedestal). This reduces the thermal resistance between the POM and the heatsink assembly and allows for more efficient and improved cooling of high power POMs, potentially allowing POMs to be air-cooled or liquid-cooled in environments where this was not previously feasible. While there remain thermal resistances through the shear resistant bearing surface, through the compressible material, and at each material-to-material transition, the elimination of the majority of the air gaps provides a net improvement.

In one embodiment, the present disclosure provides a shear resistant conformal thermal gap filler assembly for a circuit pack including a heatsink base collocated with an opening in a cage adapted to receive a POM, a thermally conductive compressible material layer disposed on the heatsink base, and a thermally conductive shear resistant bearing surface disposed adjacent to the thermally conductive compressible material layer opposite the heatsink base, where the thermally conductive shear resistant bearing surface is adapted to contact a surface of the POM through the opening in the cage when the POM is received within the cage, and where the thermally conductive compressible material layer and the thermally conductive shear resistant bearing surface are adapted to conform to deviations in the surface of the POM. The thermally conductive compressible material layer is manufactured from aligned graphite or another material that rebounds with limited compression set. The thermally conductive shear resistant bearing surface is manufactured from a metallic material or another material that is flexible. The shear resistant bearing surface may include a plurality of slits or openings along a front-to-back axis of the POM, forming a plurality of strips or connected members of the shear resistant bearing surface each able to flex with respect to one another. The shear resistant bearing surface may also include relief cuts at ends of the slits or openings, allowing the plurality of strips or connected members of the shear resistant bearing surface to further flex with respect to one another. The shear resistant conformal thermal gap filler assembly may also include a tapered lead-in retainer adapted to fixedly secure the thermally conductive compressible material layer and the thermally conductive shear resistant bearing surface to the heatsink base. The shear resistant conformal thermal gap filler assembly may further include a tapered rear retainer adapted to secure the thermally conductive compressible material layer and the thermally conductive shear resistant bearing surface to the heatsink base, while allowing a degree of translation of the thermally conductive compressible material layer and the thermally conductive shear resistant bearing surface with respect to the heatsink base along the front-to-back axis of the POM. The shear resistant conformal thermal gap filler assembly may still further include a TIM layer disposed on the thermally conductive shear resistant bearing surface opposite the thermally conductive compressible material layer, where the thermally conductive shear resistant bearing surface is adapted to contact the surface of the POM through the opening in the cage and through the TIM layer when the POM is received within the cage.

In another embodiment, the present disclosure provides a circuit pack including a printed circuit board (PCB), a cage disposed on the PCB and adapted to receive a POM, a heatsink assembly coupled to the cage and including a heatsink base collocated with an opening in the cage, and a shear resistant conformal thermal gap filler assembly. The shear resistant thermal gap filler assembly includes a thermally conductive compressible material layer disposed on the heatsink base and a thermally conductive shear resistant bearing surface disposed adjacent to the thermally conductive compressible material layer opposite the heatsink base, where the thermally conductive shear resistant bearing surface is adapted to contact a surface of the POM through the opening in the cage when the POM is received within the cage, and where the thermally conductive compressible material layer and the thermally conductive shear resistant bearing surface are adapted to conform to deviations in the surface of the POM. The thermally conductive compressible material layer is manufactured from aligned graphite or another material that rebounds with limited compression set and the thermally conductive shear resistant bearing surface is manufactured from a metallic material or another material that is flexible. The shear resistant bearing surface may include a plurality of slits or openings along a front-to-back axis of the POM, forming a plurality of strips or connected members of the shear resistant bearing surface each able to flex with respect to one another. The shear resistant bearing surface may also include relief cuts at ends of the slits or openings, allowing the plurality of strips or connected members of the shear resistant bearing surface to further flex with respect to one another. The shear resistant conformal thermal gap filler assembly may also include a tapered lead-in retainer adapted to fixedly secure the thermally conductive compressible material layer and the thermally conductive shear resistant bearing surface to the heatsink base. The shear resistant conformal thermal gap filler assembly may further include a tapered rear retainer adapted to secure the thermally conductive compressible material layer and the thermally conductive shear resistant bearing surface to the heatsink base, while allowing a degree of translation of the thermally conductive compressible material layer and the thermally conductive shear resistant bearing surface with respect to the heatsink base along a front-to-back axis of the POM. The shear resistant conformal thermal gap filler assembly may still further include a TIM layer disposed on the thermally conductive shear resistant bearing surface opposite the thermally conductive compressible material layer, where the thermally conductive shear resistant bearing surface is adapted to contact the surface of the POM through the opening in the cage and through the TIM layer when the POM is received within the cage.

In a further embodiment, the present disclosure provides a method for providing a shear resistant conformal thermal gap filler assembly for a circuit pack including providing a heatsink base collocated with an opening in a cage adapted to receive a POM, disposing a thermally conductive compressible material layer on the heatsink base, and disposing a thermally conductive shear resistant bearing surface adjacent to the thermally conductive compressible material layer opposite the heatsink base, where the thermally conductive shear resistant bearing surface is adapted to contact a surface of the POM through the opening in the cage when the POM is received within the cage, and where the thermally conductive compressible material layer and the thermally conductive shear resistant bearing surface are adapted to conform to deviations in the surface of the POM. The thermally conductive compressible material layer is manufactured from aligned graphite or another material that rebounds with limited compression set and the thermally conductive shear resistant bearing surface is manufactured from a metallic material or another material that is flexible. The shear resistant bearing surface may include a plurality of slits or openings along a front-to-back axis of the POM, forming a plurality of strips or connected members of the shear resistant bearing surface each able to flex with respect to one another. The method may also include disposing a TIM layer on the thermally conductive shear resistant bearing surface opposite the thermally conductive compressible material layer, where the thermally conductive shear resistant bearing surface is adapted to contact the surface of the POM through the opening in the cage and through the TIM layer when the POM is received within the cage.

It will be readily apparent to those of ordinary skill in the art that aspects and features of each of the described embodiments may be incorporated, omitted, and/or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate, and in which:

FIG. 1 illustrates one embodiment of the PCB, POM cage, POM, and heatsink assembly of the circuit pack of the present disclosure;

FIG. 2 illustrates one embodiment of the POM of the present disclosure, highlighting the dry sliding contact surface on the top (or bottom) of the POM;

FIG. 3 illustrates one embodiment of the heatsink assembly of the present disclosure, highlighting the dry sliding contact surface on the heatsink base (or pedestal) that protrudes through the POM cage to contact the POM contact surface;

FIG. 4 illustrates the generalized surface form deviation, waviness, texture, and roughness of the POM contact surface and the heatsink base contact surface that result in gaps that increase thermal resistance between the POM and the heatsink assembly when the POM is inserted into the POM cage;

FIG. 5A illustrates bare metal-to-metal contact between a POM contact surface and a heatsink base contact surface that results in larger gaps that increase thermal resistance between the POM and the heatsink assembly when the POM is inserted into the associated POM cage;

FIG. 5B illustrates TIM contact between a POM contact surface and a heatsink base contact surface that results in smaller gaps that increase thermal resistance between the POM and the heatsink assembly when the POM is inserted into the associated POM cage;

FIG. 5C illustrates one embodiment of the shear resistant conformal thermal gap filler assembly of the present disclosure disposed between a POM contact surface and a heatsink base contact surface that eliminates gaps that increase thermal resistance between the POM and the heatsink assembly when the POM is inserted into the associated POM cage;

FIG. 6 illustrates one embodiment of the shear resistant conformal thermal gap filler assembly of the present disclosure;

FIG. 7 illustrates a cross-section of one embodiment of the shear resistant conformal thermal gap filler assembly of the present disclosure; and

FIG. 8 illustrates another cross-section of one embodiment of the shear resistant conformal thermal gap filler assembly of the present disclosure; and

FIG. 9 illustrates one embodiment of the shear resistant conformal thermal gap filler method of the present disclosure.

It will be readily apparent to those of ordinary skill in the art that aspects and features of each of the illustrated embodiments may be incorporated, omitted, and/or combined as desired in a given application, without limitation.

### DETAILED DESCRIPTION

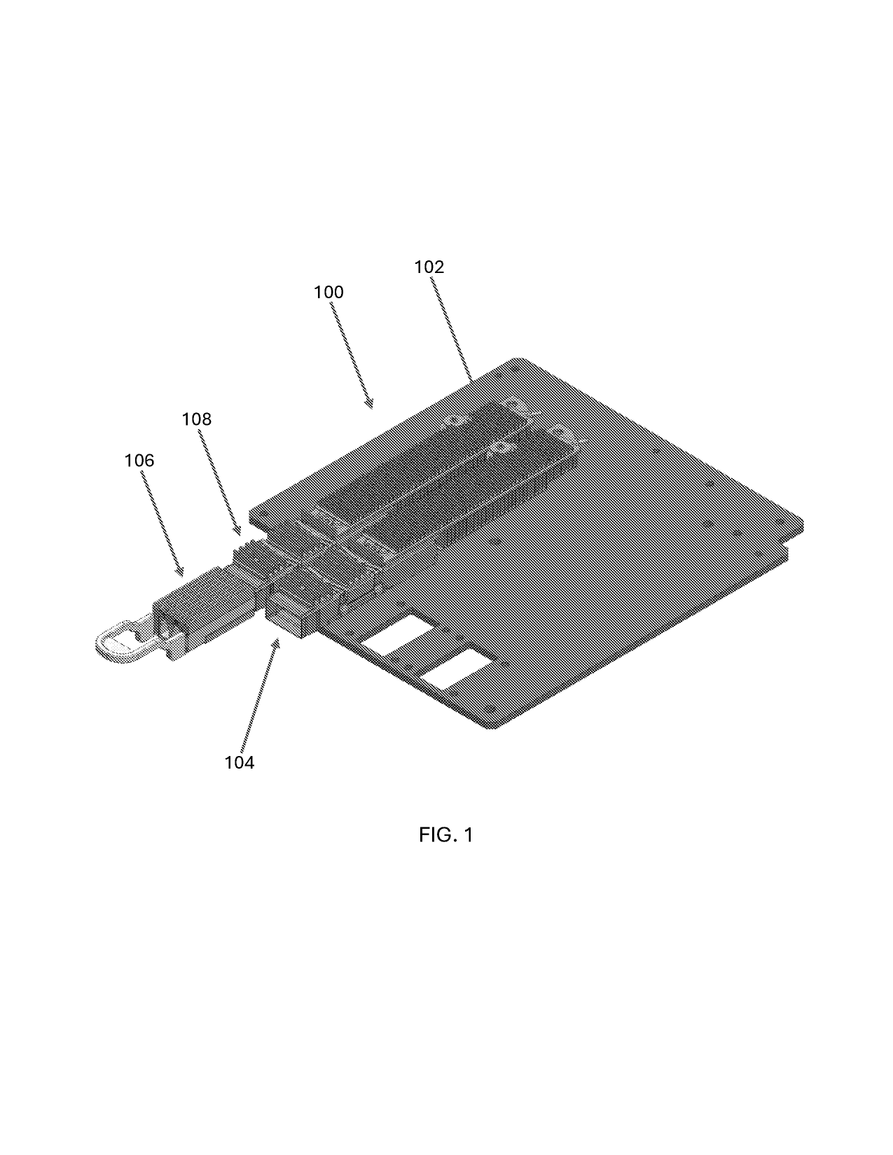

Referring now specifically to FIG. 1, the circuit pack 100 of the present disclosure includes a PCB 102 disposed within a housing (not illustrated). One or more POM cages 104 are disposed on and coupled to the PCB 102 and are configured to selectively receive one or more corresponding POMs 106. Each of the POM cages 104 includes a corresponding coupled heatsink assembly 108 that serves to cool the POM 106 through an opening in the POM cage 104 when the POM 106 is inserted into the POM cage 104. In the embodiment illustrated, the POM cages 104, POMs 106, and heatsink assemblies 108 are disposed on a primary side of the PCB 102, however, instead or in addition, the POM cages 104, POMs 106, and heatsink assemblies 108 could be disposed on a secondary side of the PCB 102. Further, the POM cages 104 and POMs 106 could be disposed on one side of the PCB 102, with the heatsink assemblies 108 disposed on another side of the PCB 102, the heatsink assemblies 108 serving to cool the POMs 106 through openings in both the PCB 102 and the POM cages 104.

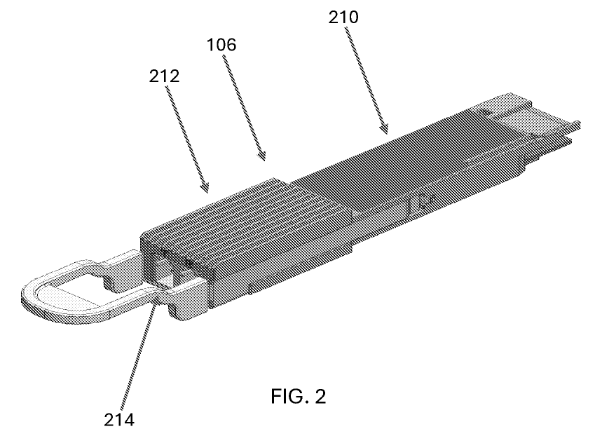

FIG. 2 illustrates the POM 106, highlighting the dry sliding contact surface 210 on the top (or bottom) of the POM 106 that contacts the heatsink assembly 108 of the associated POM cage 104 through the opening in the POM cage 104 (and, optionally, the PCB 102) when the POM 106 is inserted into the POM cage 104. In the embodiment illustrated, the front portion of the POM 106 includes its own integrated heatsink 212 adjacent the associated plug receptacles 214, separate from the heatsink assembly 108 of the POM cage 104 that is collocated with the PCB 102. The POM contact surface 210 is positioned such that it contacts the heatsink base contact surface through the opening in the POM cage 104 when the POM 106 is inserted into the POM cage 104.

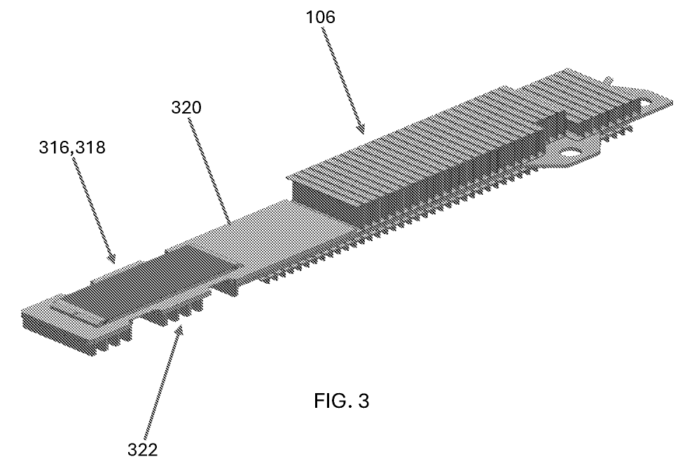

FIG. 3 illustrates the heatsink assembly 108 that is coupled to the POM cage 104. In this case, a primary side heatsink assembly 108 is shown in an upside down configuration, or a secondary side heatsink assembly 108 is shown in a right-side up configuration. The heatsink assembly 108 includes a heatsink base (or pedestal) 316 that is configured to protrude through the opening in the POM cage 104 (and, optionally, the PCB 102) in the area of the POM contact surface 210. The heatsink base contact surface 318 is disposed on and coupled to the heatsink base 316 and makes dry sliding thermal contact with the POM contact surface 210 when the POM 106 is inserted into the POM cage 104. The heatsink assembly 108 generally includes a planar structure 320 from which the heatsink base (or pedestal) 316 protrudes, as well as a plurality of heatsink fins 322, which may protrude from planar structure 320 opposite the heatsink base 316 or on the same side as the heatsink base 316 behind the POM cage 104 and inserted POM 106.

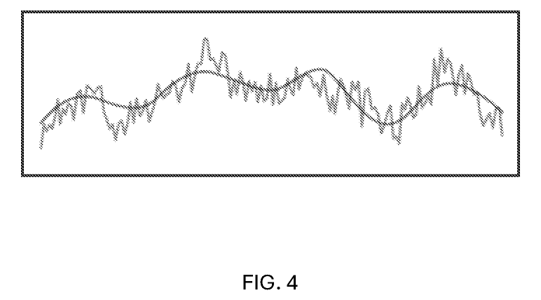

FIG. 4 illustrates the generalized surface form deviation, waviness, texture, and roughness of the POM contact surface 210 and the heatsink base contact surface 318 that result in gaps that increase thermal resistance between the POM 106 and the heatsink assembly 108 when the POM 106 is inserted into the POM cage 104. It is these gaps that the shear resistant conformal thermal gap filler assembly is intended to fill and mitigate.

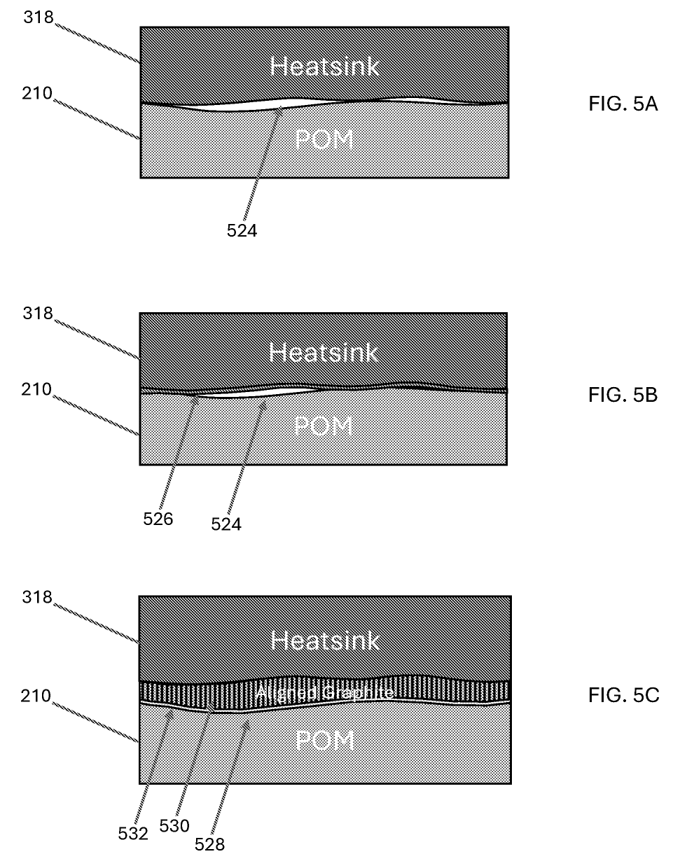

FIG. 5A illustrates bare metal-to-metal contact between a POM contact surface 210 and a heatsink base contact surface 318 that results in larger gaps 524 that increase thermal resistance between the POM 106 and the heatsink assembly 108 when the POM 106 is inserted into the associated POM cage 104. As mentioned above, improvements to bare metal-to-metal contact have included the placement of a thermal gap pad between the POM contact surface 210 and the heatsink base contact surface 318. This thermal gap pad tends to be thick and itself have significant thermal resistance and is prone to compression set. Furthermore, the tackiness and weakness of a conventional gap pad does not allow for insertion and removal of the POM 106 without an additional mechanism for lifting and dropping the heatsink assembly 108.

FIG. 5B illustrates TIM contact between a POM contact surface 210 and a heatsink base contact surface 318 that results in smaller gaps 524 that increase thermal resistance between the POM 106 and the heatsink assembly 108 when the POM 106 is inserted into the associated POM cage 104. The application of this thin, durable, and compliant TIM layer 526 to the heatsink base 316 often fails to fully close all gaps 524. Likewise, the application of a laminate of a polymer and a phase-change material 526 to the heatsink base 316, with the phase-change material transitioning to conform to the interstitial space when the POM 106 becomes warm and the polymer allowing the surfaces 210318 to slide against one another over multiple POM insertion-removal cycles often fails to fully close all gaps 524. Further, both TIM and laminate layers 526 are prone to shear damage with POM insertion/removal.

The TIM and similar approaches generally improve the contact between the POM 106 and the heatsink assembly 108 in the existing contact patches, but still result in high thermal resistance gaps 524. While the thickness of the TIM coating 526 is on the order of 20 µm, the flatness of the heatsink contact surface 318 is on the order of 25 µm and the flatness of the POM 106 is on the order of 25-50 µm. This means that the interstitial space may have broad gaps 524 with a thickness of 75 µm in some regions. Complete compression of the 20-µm TIM 526 – which is practically unobtainable – is far from sufficient to bridge a 75-µm gap. The long term reliability of the TIM 526 also degrades with multiple insertions since the TIM 526 rides along the top (or bottom) surface of the POM 106 as it is inserted into the POM cage 104.

FIG. 5C illustrates one embodiment of the shear resistant conformal thermal gap filler assembly 528 of the present disclosure disposed between a POM contact surface 210 and a heatsink base contact surface 318 that eliminates gaps 524 that increase thermal resistance between the POM 106 and the heatsink assembly 108 when the POM 106 is inserted into the associated POM cage 104. The shear resistant conformal thermal gap filler assembly 528 generally includes a compressible (elastic) material 530 applied to the heatsink base (or pedestal) 316 and covered by a shear resistant bearing surface 532 that directly contacts the POM contact surface 210 when the POM 106 is inserted into the associated POM cage 104. The compressible material 530 includes, for example, a 0.5-1 mm thick layer of aligned graphite or the like that is thermally conductive (10-80 W/mK) and (elastically) rebounds with limited compression set with removal of the POM 106 from the associated POM cage 104. The shear resistant bearing surface 532 includes a thin slotted metallic structure or the like that adequately flexes and conforms to the POM contact surface 210 and the compressible material 530, while protecting the compressible material 530 from shear damage with POM insertion/removal. A TIM coating may be provided on the shear resistant bearing surface 532 opposite the compressible material 530 to further improve (reduce) the contact/thermal resistance between the heatsink base 316 and the POM contact surface 210. A lead-in retaining feature may be utilized to protect the leading edge of the shear resistant bearing surface 532 during POM insertion. This lead-in retaining feature may be secured to the heatsink base 316 in a fixed manner. A back end retaining feature may be secured to the heatsink base 316 and allow for some movement of the shear resistant bearing surface 532 along the front-to-back length axis of the POM 106 to ensure flexibility and take up tolerances. The thin and slotted nature of the shear resistant bearing surface 532 and the compressibility of the material underneath collectively serve to fill the majority of air gaps 524 between the POM contact surface 210 and the heatsink base (or pedestal) 316. This reduces the thermal resistance between the POM 106 and the heatsink assembly 108 and allows for more efficient and improved cooling of high power POMs 106, potentially allowing POMs 106 to be air-cooled or liquid-cooled in environments where this was not previously feasible. While there remain thermal resistances through the shear resistant bearing surface 532, through the compressible material 530, and at each material-to-material transition, the elimination of the majority of the air gaps 524 provides a net improvement.

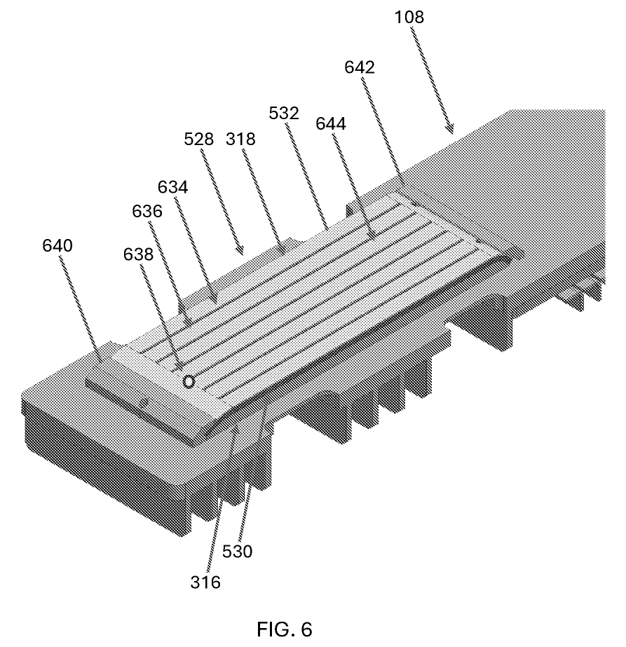

Referring now specifically to FIG. 6, in more detail, the shear resistant conformal thermal gap filler assembly 528 includes the compressible (elastic) material layer 530 disposed adjacent to the heatsink base (or pedestal) 316. The compressible material layer 530 includes, for example, a 0.5-1 mm thick layer of aligned graphite or the like that is thermally conductive (10-80 W/mK) and (elastically) rebounds with limited compression set. The compressible material layer 530 is covered and protected by the adjacent shear resistant bearing surface 532, which may be made of a metallic material, such as BeCu, stainless steel, or the like and be thin enough such that the shear resistant bearing surface 532 may flex, bend, etc. to a predetermined degree. To enhance the local conformal nature of the shear resistant bearing surface 532 with respect to the POM contact surface 210 and the compressible material layer 530, the shear resistant bearing surface 532 may include a plurality of slits or openings 634 oriented in the front-to-back axial direction of the POM 106. These slits or openings 634 form a plurality of strips or connected members 636 or even wires in the structure of the shear resistant bearing surface 532 if the slits or openings 634 are numerous enough. Circular, triangular, or other relief cuts 638 may be provided at the ends of the slits or openings 634 to further enhance this conformal nature of the shear resistant bearing surface 532, as the shear resistant bearing surface 532 may better flex locally, as well as globally. In general, this compressible material layer 530 and shear resistant bearing surface 532 form the heatsink base contact surface 318.

The shear resistant conformal thermal gap filler assembly 528 also includes a tapered lead-in retainer 640 that is coupled to the heatsink assembly 108 adjacent to the front of the heatsink base 316 and fixedly secures the compressible material layer 530 and the shear resistant bearing surface 532 to the heatsink base 316. The shear resistant conformal thermal gap filler assembly 528 further includes a tapered rear retainer 642 that is coupled to the heatsink assembly 108 adjacent to the rear of the heatsink base 316 and secures the compressible material layer 530 and the shear resistant bearing surface 532 to the heatsink base 316, optionally in a manner that allows the shear resistant bearing surface 532 to move a small amount in a front-to-back direction when the POM 106 is inserted into the POM cage 104.

The shear resistant conformal thermal gap filler assembly 528 may further include a TIM coating 644 disposed on the shear resistant bearing surface 532 opposite the compressible material layer 530 to further enhance gap filling.

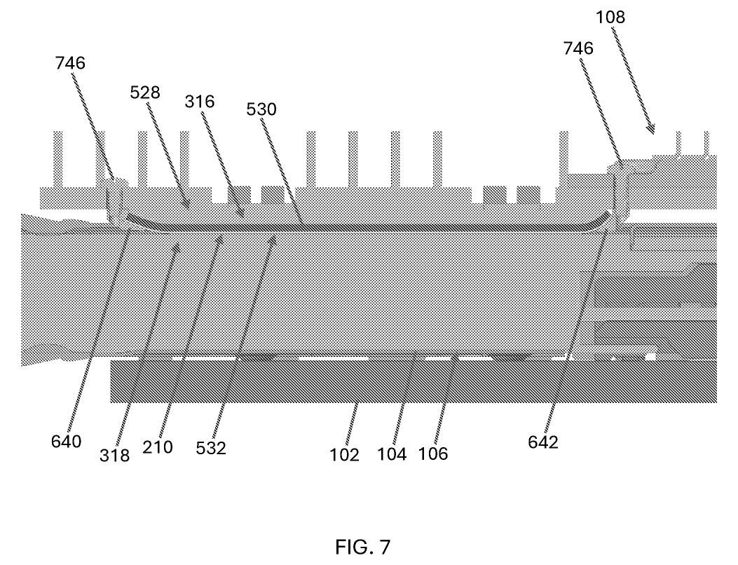

Referring now specifically to FIG. 7, in more detail, the shear resistant conformal thermal gap filler assembly 528 again includes the compressible material layer 530 disposed adjacent to the heatsink base (or pedestal) 316. The compressible material layer 530 includes, for example, a 0.5-1 mm thick layer of aligned graphite or the like that is thermally conductive (10-80 W/mK) and (elastically) rebounds with limited compression set. The compressible material layer 530 is covered and protected by the adjacent shear resistant bearing surface 532, which may be made of a metallic material, such as BeCu, stainless steel, or the like and be thin enough such that the shear resistant bearing surface 532 may flex, bend, etc. to a predetermined degree. To enhance the local conformal nature of the shear resistant bearing surface 532 with respect to the POM contact surface 210 and the compressible material layer 530, the shear resistant bearing surface 532 may include a plurality of slits or openings 634 oriented in the front-to-back axial direction of the POM 106. These slits or openings 634 form a plurality of strips or connected members 636 or even wires in the structure of the shear resistant bearing surface 532 if the slits or openings 634 are numerous enough. Circular, triangular, or other relief cuts 638 may be provided at the ends of the slits or openings 634 to further enhance this conformal nature of the shear resistant bearing surface 532, as the shear resistant bearing surface 532 may better flex locally, as well as globally. In general, the compressible material layer 530 and shear resistant bearing surface 532 form the heatsink base contact surface 318 that contacts the POM 106 when it is inserted into the POM cage 104 on the PCB 102. The shear resistant conformal thermal gap filler assembly 528 also includes the tapered lead-in retainer 640 that is coupled to the heatsink assembly 108 adjacent to the front of the heatsink base 316 via one or more screws 746 and fixedly secures the compressible material layer 530 and the shear resistant bearing surface 532 to the heatsink base 316. The shear resistant conformal thermal gap filler assembly 528 further includes the tapered rear retainer 642 that is coupled to the heatsink assembly 108 adjacent to the rear of the heatsink base 316 via one or more screws 746 and secures the compressible material layer 530 and the shear resistant bearing surface 532 to the heatsink base 316, optionally in a manner that allows the shear resistant bearing surface 532 to move a small amount in a front-to-back direction when the POM 106 is inserted into the POM cage 104.

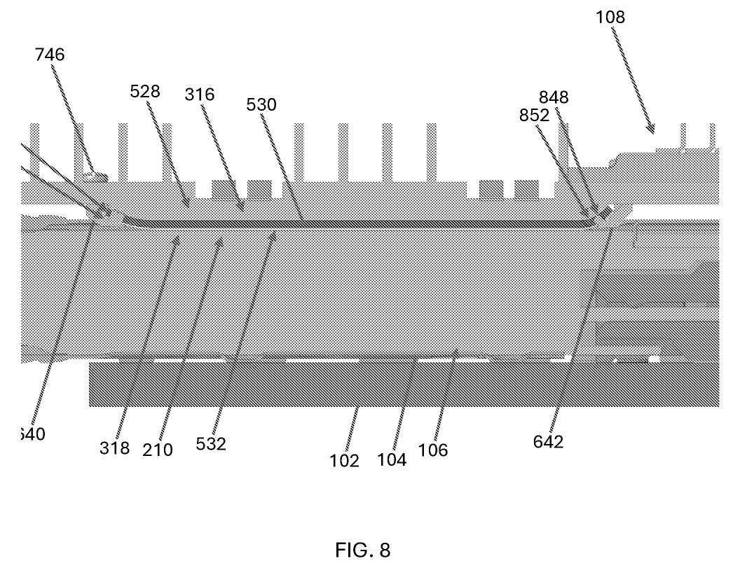

Referring now specifically to FIG. 8, in more detail, the shear resistant conformal thermal gap filler assembly 528 again includes the compressible material layer 530 disposed adjacent to the heatsink base (or pedestal) 316. The compressible material layer 530 includes, for example, a 0.5-1 mm thick layer of aligned graphite or the like that is thermally conductive (10-80 W/mK) and (elastically) rebounds with limited compression set. The compressible material layer 530 is covered and protected by the adjacent shear resistant bearing surface 532, which may be made of a metallic material, such as BeCu, stainless steel, or the like and be thin enough such that the shear resistant bearing surface 532 may flex, bend, etc. to a predetermined degree. To enhance the local conformal nature of the shear resistant bearing surface 532 with respect to the POM contact surface 210 and the compressible material layer 530, the shear resistant bearing surface 532 may include a plurality of slits or openings 634 oriented in the front-to-back axial direction of the POM 106. These slits or openings 634 form a plurality of strips or connected members 636 or even wires in the structure of the shear resistant bearing surface 532 if the slits or openings 634 are numerous enough. Circular, triangular, or other relief cuts 638 may be provided at the ends of the slits or openings 634 to further enhance this conformal nature of the shear resistant bearing surface 532, as the shear resistant bearing surface 532 may better flex locally, as well as globally. In general, the compressible material layer 530 and shear resistant bearing surface 532 form the heatsink base contact surface 318 that contacts the POM 106 when it is inserted into the POM cage 104 on the PCB 102. The shear resistant conformal thermal gap filler assembly 528 also includes the tapered lead-in retainer 640 that is coupled to the heatsink assembly 108 adjacent to the front of the heatsink base 316 via one or more screws 746 and fixedly secures the compressible material layer 530 and the shear resistant bearing surface 532 to the heatsink base 316. The lead-in retainer 640 includes one or more pins 848 that protrude from the bottom of the lead-in retainer 640 towards the heatsink base 316, passing through one or more conformal (e.g., circular) openings 850 formed in the shear resistant bearing surface 532 and, optionally, the compressible material layer 530 to prevent the shear resistant bearing surface 532 and the compressible material layer 530 from translating along the front-to-back axis of the POM 106 when the POM 106 is inserted into or removed from the POM cage 104. It will be readily apparent to those of ordinary skill in the art that other alternative retention mechanisms may also be used. The shear resistant conformal thermal gap filler assembly 528 further includes the tapered rear retainer 642 that is coupled to the heatsink assembly 108 adjacent to the rear of the heatsink base 316 via one or more screws 746 and secures the compressible material layer 530 and the shear resistant bearing surface 532 to the heatsink base 316, optionally in a manner that allows the shear resistant bearing surface 532 to move a small amount in a front-to-back direction when the POM 106 is inserted into the POM cage 104. The rear retainer 642 also includes one or more pins 848 that protrude from the bottom of the rear retainer 642 towards the heatsink base 316, passing through one or more elongated (e.g., oval shaped) openings 852 formed in the shear resistant bearing surface 532 and, optionally, the compressible material layer 530 to allow the shear resistant bearing surface 532 and the compressible material layer 530 to translate to a predetermined degree along the front-to-back axis of the POM 106 when the POM 106 is inserted into or removed from the POM cage 104. This provides a desired degree of contact flexibility and tolerance take-up. It will be readily apparent to those of ordinary skill in the art that other alternative retention mechanisms may also be used.

As the POM 106 is slid into the POM cage 104 and begins to engage the heatsink assembly 108 the following occurs. The rear end of the POM 106 (which may be slightly misaligned in the vertical axis of the POM cage 104) contacts the lead-in retainer 640. The POM 106 aligns within the POM cage 104 and the top (or bottom) surface of the POM 106 makes contact with and slides along the shear resistant bearing surface 532. The POM 106 engages with the connector on the PCB 102 and becomes fully seated. The slits or openings 634 in the shear resistant bearing surface 532 allow for the shear resistant bearing surface 532 to conform to the POM contact surface 210, the heatsink base 316, and the compressible material layer 530 along the plug length. The rear retainer 642 has the slotted pin-type feature that allows the shear resistant bearing surface 532 to move along the POM axis and not bind when the POM 316 is inserted, ensuring maximum contact between the POM 106 and the heatsink assembly 108 without gaps.

The use of the aligned graphite or the like 530 to fill the high thermal resistance micro-voids between the POM top (or bottom) surface and the heatsink base (or pedestal) 316 is an application that solves many issues in the field of air-cooled and liquid-cooled POMs 106. The shear resistant bearing surface 532 is constructed with the slits or openings 634, or, alternatively, as multiple pieces (e.g., strips, connected members, or wires), such that the shear resistant bearing surface 532 consists of an array of independently conformable sub-surfaces. The aspect ratio of each sub-surface is relatively large (e.g., 30 mm long x 3 mm wide) which allows each sub-surface to both bend and twist with greater freedom than a single large shear resistant bearing surface 532, and to bend and twist independently of adjacent sub-surfaces. This freedom of motion allows for superior conformability to the mating part. The TIM 644 on the flexible shear resistant bearing surface 532 is an adoption of the TIM 644 beyond its normal application.

Regarding the shear resistant bearing surface 532 (i.e., the shear plate); the shear plate 532 is in principle a stiff elastic membrane. When the shear plate 532 is constructed primarily as a sheet metal rectangle, the shear plate 532 is free to bend along one primary axis and/or to twist along a neutral spine with little resistance. When used to conform to the somewhat random flatness deviations present on the POM case top (or bottom), the conformability of the shear plate 532 is limited and insufficient. In other words, for a single large stiff elastic membrane to conform to the POM case top (or bottom), an unreasonable force needs to be applied to the shear plate 532. By slitting the shear plate 532, multiple sub-plates (e.g., strips, connected members, or wires) are effectively created. Each sub-plate is free to bend along one primary axis and/or to twist along a neutral spine with proportionally less resistance than would be associated with one large shear plate 532. With each sub-plate free to deform independently of the other sub-plates, a better total conformability with the POM case top (or bottom) is achieved.

For the purpose of closing local gaps ranging from null thickness (i.e., direct surface-to-surface contact) to 75-µm thick (i.e., the biggest gaps between the POM 106 and the heat sink assembly 108), the aligned graphite pad 530 must conform to both the heat sink base (or pedestal) 316 and the POM 106. A design target may be for the aligned graphite pad 530 to compress by 10% so that the aligned graphite pad 530 remains in its elastic range and does not experience compression set (i.e., permanent deformation). A 1.5-mm thick aligned graphite pad 530 may suffice, as 5% of this thickness is 75 µm, which is sufficient to close the 75-µm gaps in this example. As a verification of thermal effectiveness, the aligned graphite pad’s thermal resistance (R_{PAD}) is calculated as R_{PAD} = t/kA, where t is the thickness of the aligned graphite pad 530 and A is the contact area between the POM 106 and the heatsink base 316. For QSFP-DD cooling where the contact area is 33 x 16 mm, R_{PAD} = 0.071 °C/W. For a future 50W POM 106, with 90% of its heat leaving the case top and flowing into the heatsink 108 or cold plate, the associated temperature penalty of the aligned graphite gap pad 530 is 3 °C. This penalty is small compared to the penalty associated with air in the interstitial space, by one order of magnitude (~10x).

There remains the dry metal-to-metal contact between shear resistant bearing plate 532 and the POM 106, which constitutes a remaining thermal resistance. Because the shear plate 532, divided into sub-plates, is designed to conform to the POM case top (or bottom), it is expected to have a reduced thermal resistance – by an order of magnitude (~10x) – relative to the dry metal-to-metal contact associated with the standard heatsink 108 against POM 106. When the shear plate 532 is treated with TIM 644 on its surface bearing against the POM 106, a further benefit is achieved.

In a simplified summary, the shear resistant conformal thermal gap filler assembly 528 of the present disclosure eliminates gaps via, from the heatsink assembly 108 towards the POM 106: the heatsink assembly 108, the compressible material layer 530 conforming to the rough and un-flat surface of the heatsink base 316, the thickness of the compressible material layer 530 when elastically compressed, the shear resistant bearing plate 532 having low roughness and some flatness and conforming to the shape of the inserted POM 106 and the compressible material layer 530, the thickness of the shear resistant bearing plate 532, and the TIM 644 having a thickness and conforming to the shear resistant bearing plate 532 and the POM 106.

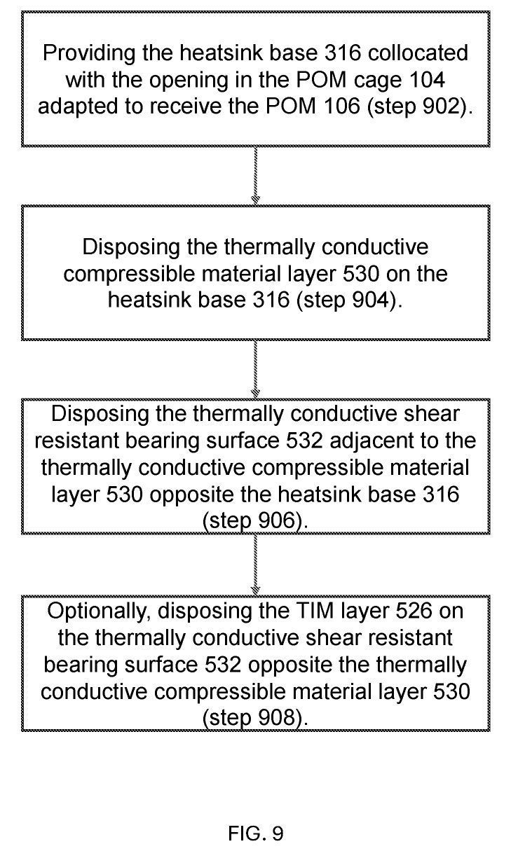

Referring to FIG. 9, the method 900 for providing the shear resistant conformal thermal gap filler assembly 528 of the present disclosure includes providing the heatsink base 316 collocated with the opening in the POM cage 104 adapted to receive the POM 106 (step 902), disposing the thermally conductive compressible material layer 530 on the heatsink base 316 (step 904), and disposing the thermally conductive shear resistant bearing surface 532 adjacent to the thermally conductive compressible material layer 530 opposite the heatsink base 316 (step 906), where the thermally conductive shear resistant bearing surface 532 is adapted to contact the surface (top or bottom) 210 of the POM 106 through the opening in the POM cage 104 when the POM 106 is received within the POM cage 104, and where the thermally conductive compressible material layer 530 and the thermally conductive shear resistant bearing surface 532 are adapted to conform to deviations in the surface 210 of the POM 106. The method 900 may also include disposing the TIM layer 526 on the thermally conductive shear resistant bearing surface 532 opposite the thermally conductive compressible material layer 530 (step 908), where the thermally conductive shear resistant bearing surface 532 is adapted to contact the surface 210 of the POM 106 through the opening in the POM cage 104 and through the TIM layer 526 when the POM 106 is received within the POM cage 104.

Although the present disclosure is illustrated and described with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A shear resistant conformal thermal gap filler assembly for a circuit pack comprising
a heatsink base collocated with an opening in a cage adapted to receive a pluggable optimal module,
a thermally conductive compressible material layer disposed on the heatsink base, and
a thermally conductive shear resistant bearing surface disposed adjacent to the thermally conductive compressible material layer opposite the heatsink base,
wherein the thermally conductive shear resistant bearing surface is adapted to contact a surface of the pluggable optical module through the opening in the cage when the pluggable optical module is received within the cage.

2. The shear resistant conformal thermal gap filler assembly of claim 1, wherein the thermally conductive compressible material layer is adapted to conform to deviations in a surface of the heatsink base and the thermally conductive compressible material layer and the thermally conductive shear resistant bearing surface are adapted to conform to deviations in the surface of the pluggable optical module.

3. The shear resistant conformal thermal gap filler assembly of claim 1, wherein
the thermally conductive compressible material layer is manufactured from aligned graphite or another material that rebounds with limited compression set, and
the thermally conductive shear resistant bearing surface is manufactured from a metallic material or another material that is flexible.

4. The shear resistant conformal thermal gap filler assembly of claim 1, wherein the shear resistant bearing surface includes a plurality of slits or openings along a front-to-back axis of the pluggable optical module, forming a plurality of strips or connected members of the shear resistant bearing surface each able to flex with respect to one another.

5. The shear resistant conformal thermal gap filler assembly of claim 4, wherein the shear resistant bearing surface includes relief cuts at ends of the slits or openings, allowing the plurality of strips or connected members of the shear resistant bearing surface to further flex with respect to one another.

6. The shear resistant conformal thermal gap filler assembly of claim 1, further comprising a tapered lead-in retainer adapted to fixedly secure the thermally conductive compressible material layer and the thermally conductive shear resistant bearing surface to the heatsink base.

7. The shear resistant conformal thermal gap filler assembly of claim 1, further comprising a tapered rear retainer adapted to secure the thermally conductive compressible material layer and the thermally conductive shear resistant bearing surface to the heatsink base, while allowing a degree of translation of the thermally conductive compressible material layer and the thermally conductive shear resistant bearing surface with respect to the heatsink base along a front-to-back axis of the pluggable optical module.

8. The shear resistant conformal thermal gap filler assembly of claim 1, further comprising a thermal interface material layer disposed on the thermally conductive shear resistant bearing surface opposite the thermally conductive compressible material layer, wherein the thermally conductive shear resistant bearing surface is adapted to contact the surface of the pluggable optical module through the opening in the cage and through the thermal interface material layer when the pluggable optical module is received within the cage.

9. A circuit pack comprising
a printed circuit board,
a cage disposed on the printed circuit board and adapted to receive a pluggable optimal module,
a heatsink assembly coupled to the cage and including a heatsink base collocated with an opening in the cage, and
a shear resistant conformal thermal gap filler assembly comprising
a thermally conductive compressible material layer disposed on the heatsink base, and
a thermally conductive shear resistant bearing surface disposed adjacent to the thermally conductive compressible material layer opposite the heatsink base,
wherein the thermally conductive shear resistant bearing surface is adapted to contact a surface of the pluggable optical module through the opening in the cage when the pluggable optical module is received within the cage.

10. The circuit pack of claim 9, wherein the thermally conductive compressible material layer is adapted to conform to deviations in a surface of the heatsink base and the thermally conductive compressible material layer and the thermally conductive shear resistant bearing surface are adapted to conform to deviations in the surface of the pluggable optical module.

11. The circuit pack of claim 9, wherein
the thermally conductive compressible material layer is manufactured from aligned graphite or another material that rebounds with limited compression set, and
the thermally conductive shear resistant bearing surface is manufactured from a metallic material or another material that is flexible.

12. The circuit pack of claim 9, wherein the shear resistant bearing surface includes a plurality of slits or openings along a front-to-back axis of the pluggable optical module, forming a plurality of strips or connected members of the shear resistant bearing surface each able to flex with respect to one another.

13. The circuit pack of claim 12, wherein the shear resistant bearing surface includes relief cuts at ends of the slits or openings, allowing the plurality of strips or connected members of the shear resistant bearing surface to further flex with respect to one another.

14. The circuit pack of claim 9, wherein the shear resistant conformal thermal gap filler assembly further comprises a tapered lead-in retainer adapted to fixedly secure the thermally conductive compressible material layer and the thermally conductive shear resistant bearing surface to the heatsink base.

15. The circuit pack of claim 9, wherein the shear resistant conformal thermal gap filler assembly further comprises a tapered rear retainer adapted to secure the thermally conductive compressible material layer and the thermally conductive shear resistant bearing surface to the heatsink base, while allowing a degree of translation of the thermally conductive compressible material layer and the thermally conductive shear resistant bearing surface with respect to the heatsink base along a front-to-back axis of the pluggable optical module.

16. The circuit pack of claim 9, wherein the shear resistant conformal thermal gap filler assembly further comprises a thermal interface material layer disposed on the thermally conductive shear resistant bearing surface opposite the thermally conductive compressible material layer, wherein the thermally conductive shear resistant bearing surface is adapted to contact the surface of the pluggable optical module through the opening in the cage and through the thermal interface material layer when the pluggable optical module is received within the cage.

17. A method for providing a shear resistant conformal thermal gap filler assembly for a circuit pack comprising
providing a heatsink base collocated with an opening in a cage adapted to receive a pluggable optimal module,
disposing a thermally conductive compressible material layer on the heatsink base, and
disposing a thermally conductive shear resistant bearing surface adjacent to the thermally conductive compressible material layer opposite the heatsink base,
wherein the thermally conductive shear resistant bearing surface is adapted to contact a surface of the pluggable optical module through the opening in the cage when the pluggable optical module is received within the cage.

18. The method of claim 17, wherein
the thermally conductive compressible material layer is manufactured from aligned graphite or another material that rebounds with limited compression set, and
the thermally conductive shear resistant bearing surface is manufactured from a metallic material or another material that is flexible.

19. The method of claim 17, wherein the shear resistant bearing surface includes a plurality of slits or openings along a front-to-back axis of the pluggable optical module, forming a plurality of strips or connected members of the shear resistant bearing surface each able to flex with respect to one another.

20. The method of claim 17, further comprising disposing a thermal interface material layer on the thermally conductive shear resistant bearing surface opposite the thermally conductive compressible material layer, wherein the thermally conductive shear resistant bearing surface is adapted to contact the surface of the pluggable optical module through the opening in the cage and through the thermal interface material layer when the pluggable optical module is received within the cage.
